(19) United States
(12) Patent Application Publication
(10) Pub. No.: US 2012/0121851 A1
(43) Pub. Date: May 17, 2012

(54) Tables and Chairs

(75) Inventor: Gianfranco Ceron, Villa Del Conte (PD) (IT)

(73) Assignee: IVOPLAST SRL, Villa Del Conte (PD) (IT)

(21) Appl. No.: 13/386,155

(22) PCT Filed: Aug. 4, 2009
(86) PCT No.: PCT/IB2009/053387

§ 371 Date: Jan. 20, 2012

(51) Int. Cl. B32B 5/02; B29C 45/14; B32B 3/06; B32B 29/00; B32B 27/00

(52) U.S. Cl. 428/99; 442/59; 428/537.5; 428/532; 264/257

(57) ABSTRACT

Tables and chairs comprising at least one surface (A) or part of said table or chair comprising a layer (M) of textile or imitation textile material or paper or cellulose-based material coated by at least one layer of rigid outer transparent or semi-transparent plastic material (P), and wherein said surface (A) or part of said table or chair is obtained by means of injection moulding or by means of injection-compression of the plastic material (P) in moulds having the shape of the surface (A) or part of said table or chair to be produced, in which the layer (M) made of textile or imitation textile material or paper or cellulose-based material has been previously positioned, so that said layer (M) made of textile or imitation textile material or paper or cellulose-based material adheres to the inner surface of said outer transparent or semi-transparent layer (P).

The present patent concerns tables and chairs and in particular concerns tables and chairs made of textile or imitation textile material with improved strength.

Tables and chairs, suitable also for positioning in gardens and outdoor areas, are known.

Said tables and chairs are currently made of wood, plastic or interwoven vegetable fibres.

Tables and chairs made of wood are easy to produce and easy to colour but have the drawbacks of being heavy and requiring regular maintenance and/or re-colouring especially if placed or left outside.

To reproduce drawings, images or artwork on wooden tables and/or chairs, they have to be done by hand or a printed support has to be applied on the surface of the furnishing element.

Hand reproduction is very expensive and can be used only for a limited number of objects.

Application of the printed support on the surface of the table or chair has the drawbacks of requiring the application of a further varnish or transparent protective layer, of being difficult to apply on forms with small radius curves or having shapes with many grooves.

Plastic tables and chairs are easy to produce and easy to colour but have the drawback of being difficult to combine in a durable manner with other materials.

Tables and chairs made of interwoven vegetable fibres are very lightweight, can be coloured uniformly or in portions or areas but cannot be coloured reproducing detailed drawings or images and it is not possible to apply a printed support on them.

Low pressure moulding systems are known which have the defect of requiring very long cycles resulting in low throughput.

The subject of the present patent is a new type of table and chair made of rigid strong textile or imitation textile material.

One object of the present invention is to obtain tables/chairs made of textile or imitation textile material resistant to wear.

A further object of the present patent is to obtain tables and/or chairs made of textile or imitation textile material resistant to abrasion.

A further object of the present patent is to obtain tables and/or chairs made of textile or imitation textile material resistant to atmospheric agents.

A further object of the present patent is to obtain tables and/or chairs made of strong textile or imitation textile material without modifying the aesthetic characteristics of the textile or imitation textile material.

A further aim of the patent is to produce chairs and tables with injection moulding techniques with high yields and high throughput.

A further advantage is that, with high pressure injection, elements that are finer in terms of thickness can be produced with respect to the techniques currently used, with consequent saving on material and therefore costs and weight.

These and further objects, direct and complementary, are achieved by the new tables and chairs made of strong textile or imitation textile material having at least the tops or exposed surfaces comprising textile or imitation textile material, paper or cellulose-based material, coated in a layer of strong transparent or semi-transparent plastic material.

Said transparent or semi-transparent plastic material allows the inner textile or imitation textile material to be fully seen, enhancing the appearance thereof.

Said transparent or semi-transparent plastic material has appropriate rigidity in order to obtain tables and chairs without the need for cores or rigid internal strengthening elements.

The textile or imitation textile material can consist of fabric, non-woven fabric or similar or if necessary also material deriving from paper or cellulose.

For each of the surfaces or parts constituting each table or chair, the textile or imitation textile material and the plastic material are joined by means of injection moulding or injection-compression.

The layer of textile or imitation textile material, in an appropriate shape, is positioned inside a mould having, on the reverse, the shape of the surface or the part constituting each table or chair to be produced.

Subsequently the plastic material is injected inside the mould.

The surface or the part constituting each table or chair thus obtained is formed of the textile or imitation textile material incorporated between two layers of resistant protective plastic (transparent) of which at least the layer exposed to view of the supporting surface or seat is transparent.

It is expedient to provide other small decorative objects, which can be applied on the part made of textile or imitation textile material before it is inserted in the plastic injection mould so that they can be seen from the outside and are protected by the transparent layer.

It is possible for each surface or part constituting each table or chair produced as above to be provided, during manufacture, with one or more accessories necessary for composition or assembly of the table or chair, such as housings for legs, hinges, fastening clips or wheels. In said case said accessories are positioned in the mould or on the closing edge of the mould before injection of the plastic material so that they are incorporated or partially incorporated in the plastic material.

The layer of plastic material can have different and varying thicknesses so that said part of the table or chair can be rigid, semi-rigid or soft and flexible, according to whether the specific portion constitutes a surface or supporting wall or interlocking element.

The characteristics of the invention will be better clarified by the following description with reference to the drawings attached by way of non-limiting example.

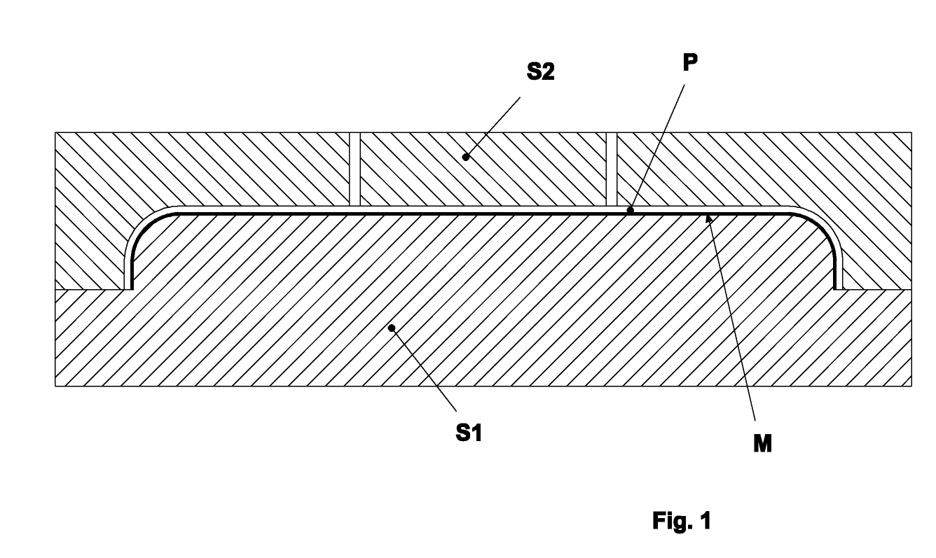

For each of the surfaces or parts constituting the table or chair, the textile or imitation textile material (M) and the plastic material (P) are joined by means of moulding in an appropriate mould (S1, S2), as illustrated in FIG. 1.

The layer of textile or imitation textile material (M), of appropriate shape, is positioned inside a mould (S1, S2) having, on the reverse, the shape of the part of the table or chair to be produced.

Subsequently the plastic material (P) is injected inside the mould (S1, S2).

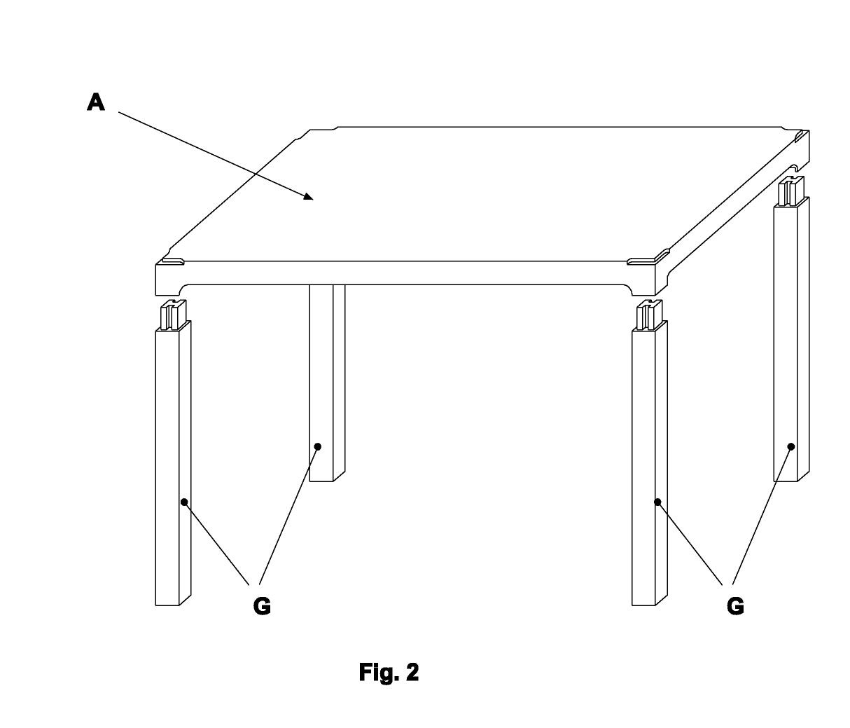

FIG. 2 illustrates an outdoor table comprising a surface (A), formed of a layer of textile or imitation textile material coated by a layer of plastic material, and supporting legs (G) which can be assembled by interlocking with said surface (A).

Therefore with reference to the preceding description and the accompanying drawings the following claims are made.

1. Tables and chairs characterised in that they comprise at least one surface or part of said table or chair comprising a layer of textile or imitation textile material or paper or cellulose-based material coated by at least one layer of rigid outer transparent or semi-transparent plastic material, and wherein said surface or part of said table or chair is obtained by means of injection moulding or by means of injection-compression of the plastic material in moulds having the shape of the surface or part of said table or chair to be produced, in which the layer made of textile or imitation textile material or paper or cellulose-based material has been previously positioned, so that said layer made of textile or imitation textile material or paper or cellulose-based material adheres to the inner surface of said outer transparent or semi-transparent layer.

2. Tables and chairs, according to claim 1, characterised in that said surfaces or parts of said table or chair comprise accessories necessary for composition or assembly of the table or chair, such as housings for legs, hinges, fastening clips or wheels, and wherein said accessories are positioned in the mould or on the closing edge of the mould prior to injection of the plastic material, thus being incorporated or partially incorporated in the plastic material.
